(19) United States
(12) Patent Application Publication
(10) Pub. No.: US 2024/0210605 A1
(43) Pub. Date: Jun. 27, 2024

(54) LIGHT-CONDENSING ELEMENT

(71) Applicant: Sony Group Corporation, Tokyo (JP)

(72) Inventors: Ryuichi TADANO, Tokyo (JP); Ilya RESHETOUSKI, Tokyo (JP)

(73) Assignee: Sony Group Corporation, Tokyo (JP)

(21) Appl. No.: 18/557,459

(22) PCT Filed: Feb. 8, 2022
(86) PCT No.: PCT/JP2022/004794

§ 371 Date: Oct. 26, 2023

(30) Foreign Application Priority Data
Jun. 15, 2021 (JP) 2021-099469

(51) Int. Cl. G02B 5/18; G02B 5/20

(52) U.S. Cl. CPC G02B 5/1842; G02B 5/1866; G02B 5/20

(57) ABSTRACT

Theres is provided a light-condensing element capable of condensing incident light having different wavelengths by a common light-condensing element. An integrated pattern is formed by integrating concentric wavelength-specific patterns set to condense incident light for each of a plurality of different wavelengths. In integrating the wavelength-specific patterns of the incident light having different wavelengths, in a case where the different wavelength-specific patterns include transmission regions that transmit the incident light and are superimposed on each other, the integrated pattern forms dithering to mix color filters formed in the transmission regions of the wavelength-specific patterns. The present disclosure may be applied to an imaging device.

### TECHNICAL FIELD

The present disclosure relates to a light-condensing element, and particularly to a light-condensing element capable of condensing incident light having different wavelengths with a common diffraction pattern.

### BACKGROUND ART

A Fresnel zone plate (FZP) has been known as a diffraction grating light-condensing element. The FZP has a diffraction pattern concentrically formed and condenses incident light at a predetermined focal length using a diffraction phenomenon (see Non-Patent Documents 1 and 2).

### CITATION LIST

### Non-Patent Documents

Non-Patent Document 1: X-Ray DATA BOOKLET Albert Thompson, David Attwood, Eric Gullikson, Malcolm Howells, Kwang-Je Kim, Janos Kirz, Jefferey Kortright, Herman Winick, Ingolf Lindau, Yanwei Liu, Piero Pianetta, Arthur Robinson, James Scofield, James Underwood, Gwyn Williams October 2009 Lawrence Berkeley National Laboratory University of California Berkeley CA 94720
Non-Patent Document 2: Takuro Yamashita, Masaru Koeda, Masaru Kawata, “The Spectral Transmittancy of Zone Plate”, Journal of the Spectroscopical Society of Japan, 1993, Vol. 42, No. 5, pp. 297-307

### SUMMARY OF THE INVENTION

### Problems to be Solved by the Invention

Meanwhile, in the FZPs of Non-Patent Documents 1 and 2, in order to condense incident light of red light, green light, and blue right (RGB) having different wavelengths at the same focal length, diffraction patterns corresponding to the RGB wavelengths are required. Therefore, in a case where the FZP is provided in a preceding stage of an imaging element, the FZP including the diffraction pattern corresponding to each of the wavelengths is required for each of the RGB pixels.

For this reason, in a case where the FZP is applied to the imaging element, the FZPs of different diffraction patterns are required for the respective pixels, and increase in labor and cost related to manufacturing is inevitable.

Therefore, it has been considered that an allowable wavelength is widened to a predetermined range of wavelengths by setting an allowable maximum focal size. However, it is difficult to satisfy light-condensing performance for distant wavelengths at the same time.

Furthermore, a light amount can be increased or decreased by increasing or decreasing the concentric light shielding regions, but the light-condensing performance is also changed at the same time, and thus the degree of freedom of sensitivity control is substantially low.

The present disclosure has been made in view of such a situation, and in particular, achieves a diffraction grating light-condensing element capable of condensing incident light having different wavelengths with a common diffraction pattern.

### Solutions to Problems

A light-condensing element according to a first aspect of the present disclosure is a light-condensing element including a concentric integrated pattern that diffracts and condenses incident light including light having a plurality of different wavelengths, in which the integrated pattern includes a first wavelength-specific pattern corresponding to a first wavelength of the incident light and a second wavelength-specific pattern corresponding to a second wavelength of the incident light.

According to the first aspect of the present disclosure, the concentric integrated pattern is provided, which diffracts and condenses the incident light including the light having the plurality of different wavelengths, and the integrated pattern includes the first wavelength-specific pattern corresponding to the first wavelength of the incident light and the second wavelength-specific pattern corresponding to the second wavelength of the incident light.

A light-condensing element according to a second aspect of the present disclosure a light-condensing element including an integrated pattern that diffracts and condenses incident light including light having a plurality of different wavelengths, in which the integrated pattern includes a first concentric first wavelength-specific pattern corresponding to a first wavelength of the incident light and a second concentric second wavelength-specific pattern corresponding to a second wavelength of the incident light and having a center position shifted from a center position of the first wavelength-specific pattern by a predetermined value.

According to the second aspect of the present disclosure, the integrated pattern is provided, which diffracts and condenses the incident light including the light having the plurality of different wavelengths, and the integrated pattern includes the first concentric first wavelength-specific pattern corresponding to the first wavelength of the incident light and the second concentric second wavelength-specific pattern corresponding to the second wavelength of the incident light and having the center position shifted from the center position of the first wavelength-specific pattern by the predetermined value.

### BRIEF DESCRIPTION OF DRAWINGS

FIG. 1 is a diagram illustrating a configuration example of an imaging device of the present disclosure.

FIG. 2 is a diagram illustrating a configuration example of a first embodiment of a light-condensing element.

FIG. 3 is a diagram illustrating a configuration of dithering in the light-condensing element of FIG. 2.

FIG. 4 is a diagram illustrating a configuration example of a second embodiment of a light-condensing element.

FIG. 5 is a diagram illustrating a configuration example of an imaging device when the light-condensing element of FIG. 4 is used.

FIG. 6 is a diagram illustrating a configuration example of a third embodiment of a light-condensing element. 20 FIG. 7 is a diagram illustrating a configuration example of a fourth embodiment of a light-condensing element.

FIG. 8 is a diagram illustrating a configuration example of a fifth embodiment of a light-condensing element.

FIG. 9 is a graph illustrating a color filter of a color including two different wavelengths.

### MODE FOR CARRYING OUT THE INVENTION

Hereinafter, a preferred embodiment of the present disclosure will be described in detail with reference to the accompanying drawings. Note that, in the following description and the drawings, components having substantially the same functional configuration are denoted by the same reference signs, and the redundant description is omitted.

Hereinafter, modes for carrying out the present technology will be described. The description is given in the following order.
1. FIRST EMBODIMENT
2. SECOND EMBODIMENT
3. THIRD EMBODIMENT
4. FOURTH EMBODIMENT
5. FIFTH EMBODIMENT

### 1. First Embodiment

The present disclosure particularly achieves a diffraction grating light-condensing element in which incident light having different wavelengths is condensed at the same focal length with a common diffraction pattern.

### <Configuration Example of Imaging Device>

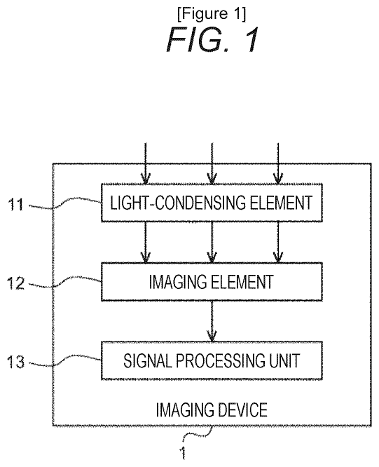

A configuration of an imaging device to which the light-condensing element of the present disclosure is applied will be described with reference to a block diagram of FIG. 1.

An imaging device 1 of FIG. 1 includes a light-condensing element 11, an imaging element 12, and a signal processing unit 13.

The light-condensing element 11 includes, for example, a Fresnel zone plate (FZP) or the like, and condenses incident light per unit of a plurality of pixels constituting the imaging element 12.

The imaging element 12 includes a complementary metal oxide semiconductor (CMOS) image sensor, a charge coupled device (CCD) image sensor, or the like, generates a pixel signal corresponding to an amount of the incident light, and outputs the pixel signal to the signal processing unit.

The signal processing unit 13 performs various types of signal processing such as noise removal and color adjustment on the pixel signal supplied from the imaging element 12, and outputs the pixel signal as image data to a device in a subsequent stage (not illustrated).

The pixel signal output from the signal processing unit 13 is stored in, for example, a storage medium (not illustrated) or displayed on a display device.

### <Configuration Example of First Embodiment of Light-Condensing Element>

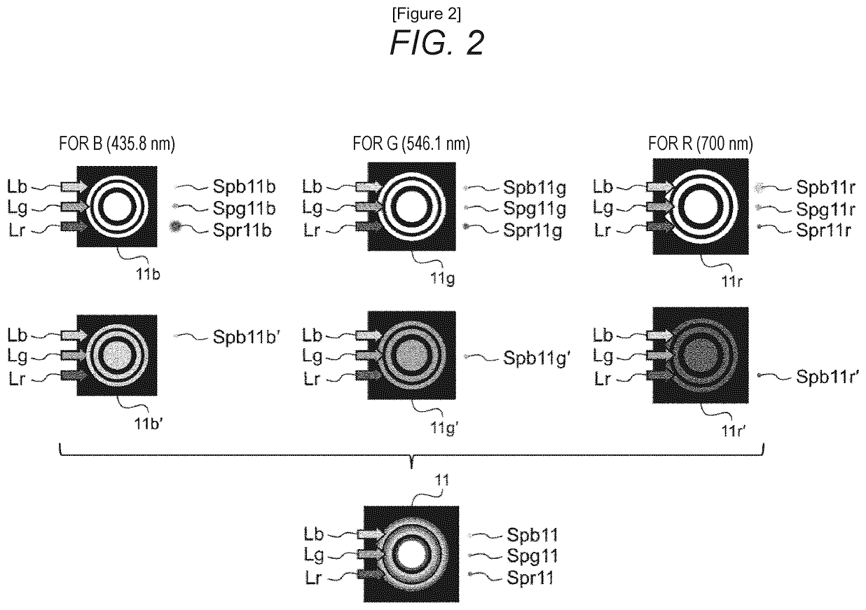

Next, a structure of the light-condensing element 11 will be described. In a case where the light-condensing element 11 is a general amplitude-type diffraction grating light-condensing element, for example, a Fresnel zone plate (FZP), the light-condensing element of FIG. 2 is configured by alternately aligning light shielding regions including concentric black regions in the figure and transmission regions including concentric white regions in the figure, and condenses the incident light per pixel on an imaging plane of the imaging element 12 using diffraction of the light transmitted through the transmission regions.

For example, in designing the light-condensing element, it is known that a radius of an n-th concentric light shielding region is defined by Formula (1) below.

$${r}_{n} = √ ( n λ f + {n}^{2} {f}^{2} / 4 ) \qquad ( 1 )$$

Here, rₙ represents the radius of the n-th concentric light shielding region, λ represents a wavelength of the incident light, and f represents a focal length.

Therefore, a diffraction pattern (hereinafter, also referred to simply as a pattern) of the concentric light shielding regions changes in accordance with the wavelength λ of the incident light.

For example, a light-condensing element 11b in an upper left part of FIG. 2 is generally a pattern when incident light of blue light (B) having a wavelength λ=435.8 nm, for example, is condensed at a predetermined focal length f.

Furthermore, a light-condensing element 11g in an upper center of FIG. 2 is generally a pattern when incident light of green light (G) having a wavelength λ=546.1 nm, for example, is condensed at the predetermined focal length f.

Moreover, a light-condensing element 11r in an upper right part of FIG. 2 is generally a pattern when incident light of red light (R) having a wavelength λ=546.1 nm, for example, is condensed at the predetermined focal length f.

When blue light Lb is incident on the light-condensing element 11b, the blue light Lb is condensed as indicated by a spot spb11b at the focal length f. Similarly, when green light Lg is incident on the light-condensing element 11b, the green light Lg is condensed as indicated by a spot spg11b at the focal length f. When red light Lr is incident on the light-condensing element 11b, the red light Lr is condensed as indicated by a spot spr11b at the focal length f.

That is, since the light-condensing element 11b has the pattern corresponding to the wavelength of the blue light Lb, when the blue light Lb is incident as the incident light, the incident light is sufficiently condensed at the focal length f, so that the spot spb11b becomes minimum. However, the green light Lg and red light Lr whose wavelengths are distant from the designed wavelength cannot be sufficiently condensed, so that the size of the spot increases in the order of the spots spg11b and spr11b.

Furthermore, when the blue light Lb is incident on the light-condensing element 11g, the blue light Lb is condensed as indicated by a spot spb11g at the focal length f. Similarly, when the green light Lg is incident on the light-condensing element 11g, the green light Lg is condensed as indicated by a spot spg11g at the focal length f. When the red light Lr is incident on the light-condensing element 11g, the red light Lr is condensed as indicated by a spot spr11g at the focal length f.

That is, since the light-condensing element 11g has a pattern corresponding to the wavelength of the green light Lg, the incident light is sufficiently condensed at the focal length f, so that the spot spg11g becomes minimum. However, the blue light Lb and the red light Lr whose wavelengths are different from the designed wavelength cannot be sufficiently condensed, so that the spot spb11g and the spot spr11g become large.

Moreover, when the blue light Lb is incident on the light-condensing element 11r, the blue light Lb is condensed as indicated by a spot spb11r at the focal length f. Similarly, when the green light Lg is incident on the light-condensing element 11r, the green light Lg is condensed as indicated by a spot spg11r at the focal length f. When the red light Lr is incident on the light-condensing element 11r, the red light Lr is condensed as indicated by a spot spr11r at the focal length f.

That is, since the light-condensing element 11r has a pattern corresponding to the wavelength of the red light Lr, the red light Lr is sufficiently condensed at the focal length f, so that the spot spr11r becomes minimum. However, the green light Lg and the blue light Lb whose wavelengths are distant from the designed wavelength cannot be sufficiently condensed, so that the size of the spot increases in the order of the spots spg11r and spb11r.

In view of such characteristics, in a case of a light-condensing element 11′ provided with a color filter that transmits the blue light Lb in the transmission regions of the light-condensing element 11b, only the blue light Lb is transmitted through the light-condensing element 11′, thus, the spot spb11b′ in which the blue light Lb is sufficiently condensed is formed at the focal length f.

Furthermore, in a case of a light-condensing element 11g′ provided with a color filter that transmits the green light Lg in the transmission regions of the light-condensing element 11g, only the green light Lg is transmitted through the light-condensing element 11g′, thus, the spot spb11g′ in which the green light Lg is sufficiently condensed is formed at the focal length f.

Similarly, in a case of a light-condensing element 11r′ provided with a color filter that transmits the red light Lr in the transmission regions of the light-condensing element 11r, only the red light Lr is transmitted through the light-condensing element 11r′, thus, the spot spb11r′ in which the red light Lr is sufficiently condensed is formed at the focal length f.

However, as indicated by the light-condensing elements 11b′, 11g′, and 11r′ of FIG. 2, in the case where the light-condensing elements are configured in different patterns in accordance with the color (wavelength) of the light to be transmitted, it is necessary to individually manufacture and arrange the light-condensing elements 11b′, 11g′, and 11r′ per pixel in accordance with a type (wavelength) of the light to be transmitted.

Furthermore, it is considered that a width is given to the wavelength of the light that can be condensed by adjusting the spot diameter at the time of condensing. However, in a case where a difference between the wavelengths is significantly larger than a predetermined value, the light-condensing performance cannot be satisfied at the same time.

Moreover, a light amount can be increased or decreased by increasing or decreasing the concentric light shielding regions, but the light-condensing performance is also changed at the same time, and thus there is substantially no degree of freedom of sensitivity control.

Therefore, in the present disclosure, as illustrated in a bottom center of FIG. 1, by configuring the light-condensing element 21 in which the patterns of the light-condensing elements 11b′, 11g′, and 11r′ are integrated, even if each of the blue light Lb, the green light Lg, and the red light Lr having different wavelengths is incident on the light-condensing element 21, each of the blue light Lb, the green light Lg, and the red light Lr is appropriately condensed at the focal length f, so that the spots spb11, spg11, and spr11 are formed.

Here, in a case where the patterns of the light-condensing elements 11b′, 11g′, and 11r′ are integrated to form a pattern including the concentric light shielding regions and the concentric transmission regions of the light-condensing element 21, conflicts occur in the transmission regions of the respective patterns of the light-condensing elements 11b′, 11g′, and 11r′.

For example, consideration is given to a case where a part of the transmission regions in the pattern of the light-condensing element 11b′ and a part of the transmission regions in the pattern of the light-condensing element 11g′ are superimposed on each other to cause the conflicts.

The color filter that transmits the blue light Lb is formed in the transmission regions of the light-condensing element 11b′, and the color filter that transmits the green light Lg is formed in the transmission regions of the light-condensing element 11g′.

Therefore, when both the transmission regions are simply superimposed on each other, both the blue light Lb and the green light Lg cannot be transmitted in a state in which the color filter that transmits the blue light Lb and the color filter that transmits the green light Lg are superimposed on each other.

Therefore, in the light-condensing element 21, the occurrence of the conflicts is suppressed by introducing dithering that expresses intermediate gradation by diffusing errors in a spatial direction for the transmission regions and the light shielding regions.

### <Dithering>

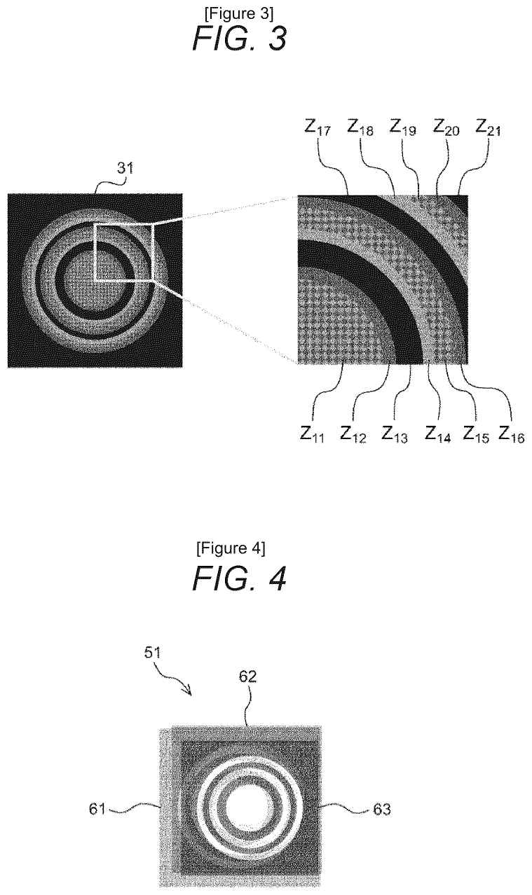

Here, in order to describe the dithering, a light-condensing element 31 is used, in which, as illustrated in FIG. 3, a concentric pattern including the transmission regions and the light shielding regions of the light-condensing element 11g′ that condenses the green light Lg and a concentric pattern including the transmission regions and the light shielding regions of the light-condensing element 11r′ that condenses the red light Lr are integrated.

Note that, a left part of FIG. 3 illustrates the entire light-condensing element 31, and a right part of FIG. 3 is an enlarged view illustrating a concentric pattern including transmission regions and light shielding regions of the light-condensing element 31.

Furthermore, in FIG. 3, regions indicated in black are the light shielding regions, regions indicated in dark gray are the transmission regions provided with the color filters that transmit the red light Lr, and regions indicated in light gray are the transmission regions provided with the color filters that transmit the green light Lg.

Since the red light Lr has the wavelength longer than the wavelength of the green light Lg, the radius of the concentric pattern including the transmission regions and the light shielding regions of the light-condensing element 11r′ for the red light Lr is also larger than that of the light-condensing element 11g′ for the green light Lg.

Therefore, when the light-condensing element 11g′ for the green light Lg and the light-condensing element 11r′ for the red light Lr are superimposed on each other, the concentric pattern of the light-condensing element 11r′ for the red light Lr is located relatively outward and the concentric pattern of the light-condensing element 11g′ for the green light Lg is located relatively inward in the same m-th transmission region.

The regions indicated in dark gray by areas Z12, Z16, and Z20 of FIG. 3 include regions where the color filters that transmit the red light Lr are formed, and include regions formed so as to extend outward from regions Z11, Z15, and Z19 relatively constituting the dithering.

Furthermore, the regions indicated in light gray by areas Z14 and Z18 of FIG. 3 include regions where the color filters that transmit the green light Lg are formed, and include regions extending inward from the regions Z15 and Z19 relatively constituting the dithering.

In the regions Z11, 215, and Z19 where the transmission regions of the light-condensing element 11g′ for the green light Lg and the transmission regions of the light-condensing element 11r′ for the red light Lr are superimposed on one another, it is necessary to contribute to condensing of the light having the respective wavelengths, and thus, the dithering is formed.

The dithering is a mixed region having a structure in which the transmission regions of the light-condensing element 11g′ for the green light Lg and the transmission regions of the light-condensing element 11r′ for the red light Lr are shared. In other words, the dithering is a mixed region having a structure in which the respective regions of the color filters that transmit the green light Lg formed in the transmission regions of the light-condensing element 11g′ and the color filters that transmit the red light Lr formed in the transmission regions of the light-condensing element 11r′ are shared and mixed.

In the regions Z11, Z15, and Z19 where the dithering is formed as illustrated in the right part of FIG. 3, regions formed with the color filters that transmit the green light Lg of the light-condensing element 11g′ for the green light Lg and regions formed with the color filters that transmit the red light Lr of the light-condensing element 11r′ for the red light Lr are mixed and arranged in a lattice pattern.

As indicated by the regions Z11, Z15, and Z19, the transmission regions formed with the color filters that transmit the green light Lg in the light-condensing element 11g′ for the green light Lg and the transmission regions formed with the color filters that transmit the red light Lr in the light-condensing element 11r′ for the red light Lr are each configured with a sufficiently fine pattern. Accordingly, it is possible to transmit any incident light having different wavelengths so as not to disturb the balance of the light condensing in the light-condensing element 31.

Note that, in the example of FIG. 3, the regions Z11, Z15, and Z19 where the dithering is formed are illustrated as regular lattice patterns for convenience, but actually, in order to avoid an unnecessary diffraction effect, a dither pattern having randomness is desirable.

The pattern constituting the region where the dithering is formed is not limited to the lattice-shaped pattern or a specific pattern, but may be a random pattern, a Bayer array pattern, a void-and-cluster array pattern, an error diffusion pattern, or the like.

### 2. Second Embodiment

In the above, the example has been described, in which, in the case where the FZP, which is an amplitude type diffractive light-condensing element in which the concentric light shielding regions and the concentric transmission regions are alternately repeated, is used as a base, the light-condensing elements 11b′, 11g′, and 11r′ for condensing the blue light Lb, the green light Lg, and the red light Lr, respectively, are integrated by superimposition with the center positions of the light-condensing elements being aligned.

However, since the light-condensing elements 11b′, 11g′, and 11r′ are superimposed on one another with the center positions being aligned, transmittance of light is reduced because the transmission regions having different wavelengths are superimposed on one another.

Therefore, as indicated by a light-condensing element 51 of FIG. 4, light-condensing elements 61 to 63 corresponding to the light-condensing elements 11b′, 11g′, and 11r′ may be integrated in such a manner that the light-condensing elements 61 to 63 are superimposed on one another with the center positions being slightly shifted from one another by a predetermined value.

In a configuration obtained by superimposing the light-condensing elements 61 to 63 on one another with the center positions being shifted in this manner, the respective transmission regions are superimposed on only a part of the respective light shielding regions, so the transmission regions become wider, and the transmittance of light can be improved.

### <Configuration Example of Imaging Device in Case of Employing Light-Condensing Element of FIG. 4>

In that case, it is necessary to correct the shift of the center position for each color channel by signal processing in the subsequent stage. In this case, it is necessary to provide, in the preceding stage of an imaging element 12, a color filter equivalent to the color filters provided in the transmission regions of the light-condensing elements 61 to 63 used in a light-condensing element 51.

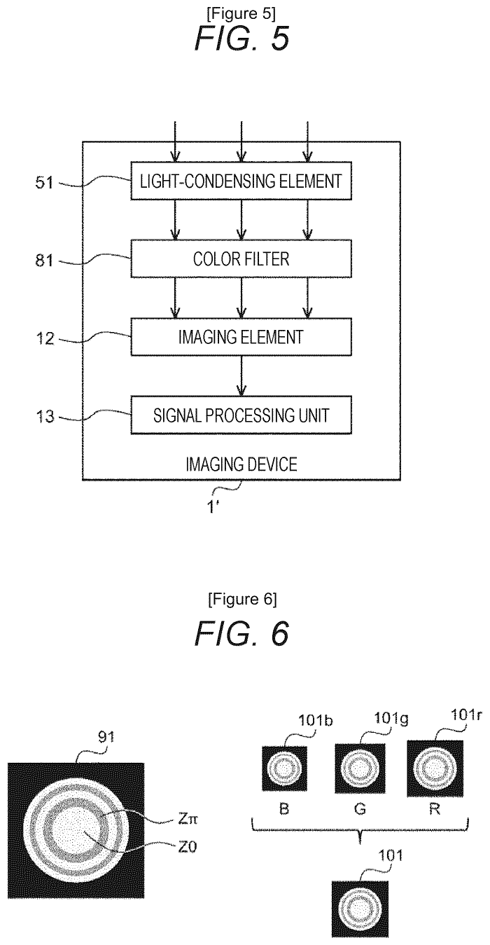

FIG. 5 illustrates a configuration example of an imaging device 1′ in a case where the light-condensing element 51 is used. In the imaging device 1′ of FIG. 5, components having the same functions as those of the imaging device 1 of FIG. 1 are denoted by the same reference signs, and the description thereof will be omitted as appropriate.

That is, the imaging device 1′ of FIG. 5 is different from the imaging device 1 of FIG. 1 in that the light-condensing element 51 is provided instead of the light-condensing element 11, and a color filter 81 is provided in the subsequent stage of the light-condensing element 51 and in the preceding stage of the imaging element 12.

That is, in the imaging device 1′ of FIG. 5, a signal processing unit 13 corrects a state in which the center positions of the light-condensing elements 61 to 63 are shifted. In this case, since the respective RGB images of blue light Lb, green light Lg, and red light Lr are captured in the state in which the center positions are shifted, it is necessary to perform correction so as to align the center positions after generating the images of the respective color channels of RGB by separating the images from the captured images. For this reason, in this configuration, it is essential to provide the color filter 81 in the preceding stage of the imaging element 12.

### 3. Third Embodiment

In the above, the description has been made on the premise of the configuration example based on the amplitude-type FZP, which is the amplitude-type diffraction grating light-condensing element in which the concentric light shielding regions and the concentric transmission regions are alternately arranged in the repetitive manner. However, a configuration based on a phase-type diffraction grating light-condensing element in which two transmission regions having a phase difference of n are concentrically and alternately arranged in a repetitive manner may be adopted.

In the phase-type diffraction grating light-condensing element, since the light shielding regions are eliminated, transmittance of light is about twice as large as that of the amplitude-type diffraction grating light-condensing element.

The phase-type diffraction grating light-condensing element is, for example, a phase-type FZP. As indicated by an FZP 91 in a left part of FIG. 6, a region Z0 including transmission regions having a phase difference of 0 (rad) and a region Zn including transmission regions having a phase difference of n (rad) are concentrically and alternately formed, so that the phase-type diffraction grating light-condensing element functions as an annular diffraction grating and accordingly functions as a light-condensing element.

The basic configuration of the light-condensing element using the phase-type diffraction grating light-condensing element is the same as that of the light-condensing element 21 of FIG. 1. That is, as illustrated in a right part of FIG. 6, a pattern in which the region Z0 including the transmission regions having the phase difference of 0 and the region Zn including the transmission regions having the phase difference of n in phase-type diffraction grating light-condensing elements 101b, 101g, and 101r designed for blue light Lb, green light Lg, and red light Lr, respectively, are concentrically and alternately formed is prepared, and patterns thus prepared are integrated to form a light-condensing element 101 in such a manner that the patterns are superimposed on one another and dithering is formed in the regions in which the respective wavelengths are superimposed on one another, and the light-condensing element 101 is mounted on an imaging device 1 instead of the light-condensing element 11 of FIG. 1.

In the case of the phase-type diffraction grating light-condensing element as indicated by the light-condensing element 101 of FIG. 6, since there is no light shielding region, it is necessary to form the dithering in all the regions.

### 4. Fourth Embodiment

In the above, the example has been described, in which the transmittance of the entire light is increased in the light-condensing element in the case where the phase-type diffraction grating light-condensing element is used as a base. However, the transmittance may be adjusted by adjusting a ratio of dithering for each color channel to achieve a sensitivity adjustment.

For example, in a case where color channels such as RGB are set for respective pixels constituting the imaging element 12, there is a difference in sensitivity among the color channels, and a white balance gain may be applied to correct the difference. For example, since it is known that the R and B channels are lower in sensitivity than the G channel, the white balance gain of one time or more is applied to the R and B channels. As a result, the R and B channels generally have a lower S/N ratio than the G channel.

In a combination of such an imaging element 12 and the light-condensing element of the present disclosure, the ratio of dithering may be adjusted among the color channels to correct the sensitivity ratio.

More specifically, by relatively lowering the ratio (area ratio) of the regions where the color filters that transmit the green light Lg are formed and relatively increasing the ratio (area ratio) of the regions where the color filters that transmit the blue light Lb or the red light Lr are formed, a state similar to a state in which a constant white balance gain is optically applied in advance is obtained, so that the balance of SN ratios of the respective color channels can be improved.

For example, in a case where standard sensitivity of R is represented by OR, sensitivity of G is represented by as, a region Fr in which color filters that transmit red light Lr are formed is represented by an R region, and a region Fg in which color filters that transmit green light Lg are formed is represented by a G region as indicated by an area Z11 of FIG. 7, it is possible to improve the balance of an SN ratio by configuring the dithering so that an aperture ratio is set to satisfy the relation represented by Formula (2) below.

$$R region : G region = {α}_{G} : {α}_{R} \qquad ( 2 )$$

### 5. Fifth Embodiment

In the above, the example has been described, in which the balance of the SN ratio is improved by setting the ratio (area ratio) of the regions where the RGB color filters are formed in the dithering, in accordance with the sensitivity of RGB.

However, the transmission regions for the light of different colors constituting the dithering may be configured by a color filter of a color having both the wavelengths of the different colors.

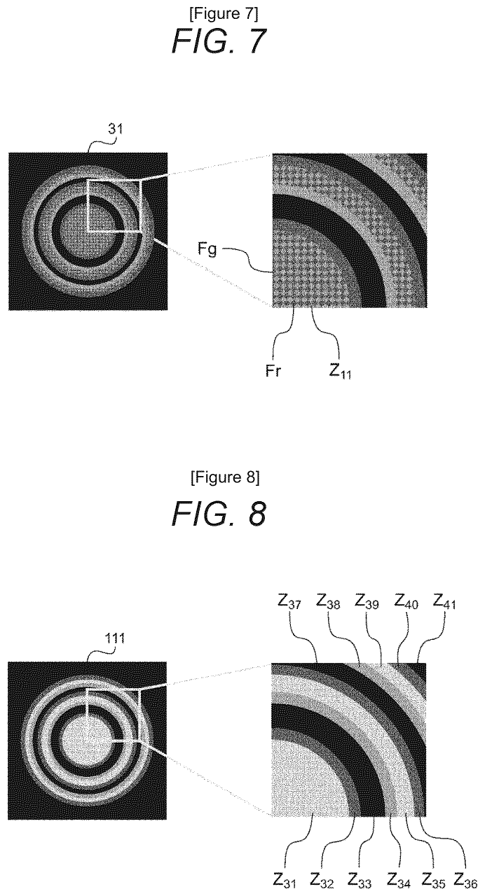

Here, in order to describe an example configured by the color filter of the color having both the wavelengths of the different colors, a light-condensing element 111 is used. In the light-condensing element 111, as illustrated in FIG. 8, a concentric pattern including transmission regions and light shielding regions of a light-condensing element 11g′ that condenses green light Lg and a concentric pattern including transmission regions and light shielding regions of a light-condensing element 11r′ that condenses red light Lr are integrated by superimposition.

Note that, a left part of FIG. 8 illustrates the entire light-condensing element 111, and a right part of FIG. 8 is an enlarged view illustrating a concentric pattern including transmission regions and light shielding regions of the light-condensing element 111.

Furthermore, regions indicated in black are light shielding regions, regions indicated in dark gray are transmission regions provided with color filters that transmit red light Lr, and regions indicated in medium gray are transmission regions provided with color filters that transmit green light Lg. Regions indicated in the lightest gray are regions where the color filters of the color including both the wavelengths of the red light Lr and the green light Lg are formed.

The regions indicated in dark gray by areas 232, Z36, and Z40 of FIG. 8 include regions that transmit the red light Lr, and include regions extending outward from regions Z31, 235, and Z39 indicated in the lightest gray in which the color filters of the color including both the wavelengths of the red light Lr and the green light Lg are formed.

Furthermore, regions indicated in medium gray by areas Z34 and Z38 of FIG. 8 include regions that transmit the green light Lg, and include regions extending inward from regions Z35 and Z39 indicated in the lightest gray in which the color filters of the color including both the wavelengths of the red light Lr and the green light Lg are formed.

In the regions 235 and Z39 where the regions formed with the color filters that transmit the green light Lg of the light-condensing element 11g′ for the green light Lg and the regions formed with the color filters that transmit the red light Lr of the light-condensing element 11r′ for the red light Lr are superimposed on each other, it is necessary to contribute to condensing of the light having the respective wavelengths, and thus, the color filters of the color including both the wavelengths of the green light Lg and the red light Lr are formed.

Here, since the region where the color filter of the color including both the wavelengths is formed is a region where the transmission regions of the light-condensing element 11g′ for the green light Lg and the light-condensing element 11r′ for the red light Lr are superimposed on each other, the regions Z31, 235, and Z39 of FIG. 8 are configured by yellow color filters of the color including both the wavelengths of the green light Lg and the red light Lr.

The yellow color filters constituting the regions Z31, Z35, and Z39 of FIG. 8 have, for example, characteristics of transmitting the light having both the wavelengths of the red light Lr and the green light Lg while shielding the light having wavelengths of other colors.

According to such characteristics, the transmission regions of the light-condensing element 11g′ for the green light Lg and the light-condensing element 11r′ for the red light Lr can be used in common without configuring the dithering. Therefore, it is expected that the light transmittance exceeds that of the dithering.

That is, the object is to mix and transmit all incident light having different wavelengths when the transmission regions for the incident light having different wavelengths are superimposed on one another in both the case where the dithering is formed and the case where the color filter of the color including both the wavelengths is formed. For this reason, it may be understood that the transmission regions for the incident light having different wavelengths are mixed in both the methods.

Furthermore, in the above, the example has been described, in which the color filter of yellow which is the color including both the green light Lg and the red light Lr, is used as the color filter of the color including both the wavelengths of the green light Lg and the red light Lr. However, in other cases, a color filter of a color including two wavelengths is used in the case of two colors.

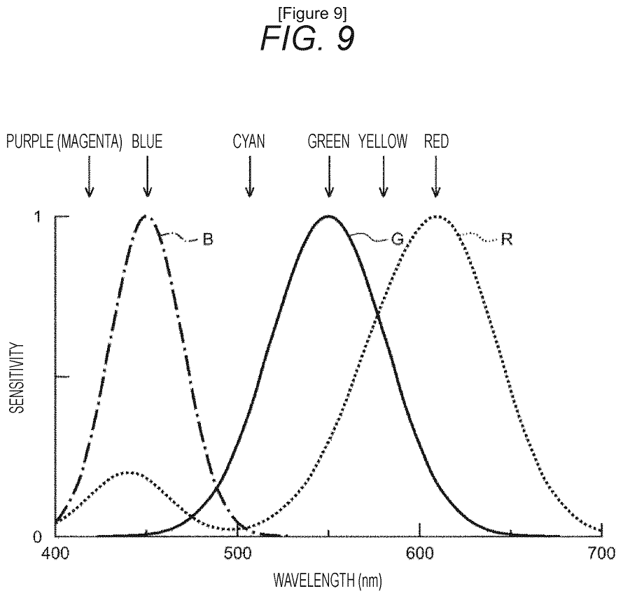

For example, as illustrated in FIG. 9, in a case where a color filter that transmits both the blue light Lb and the green light Lg is required, a color filter having such characteristics that transmit light (light of a waveform having two peaks) obtained by adding the wavelengths of both the blue light Lb and the green light Lg is used.

Furthermore, as illustrated in FIG. 9, in a case where a color filter that transmits both the blue light Lb and the red light Lr is required, a color filter of purple (magenta) including both the wavelengths of the blue light Lb and the red light Lr is used.

Moreover, in the case where the sensitivity adjustment is required as described above, in the region where the color filter of the color including both the wavelengths of the green light Lg and the red light Lr is formed, the sensitivity adjustment can also be achieved by adjusting the yellow color filter to be a greenish yellow color filter or a reddish yellow color filter.

Furthermore, the basic idea is similar in a case of three or more colors.

Moreover, as a matter of course, such a configuration can also be adopted in the case where the phase-type diffraction grating light-condensing element is used as a base.

Furthermore, in the above, the example has been described, in which the light-condensing elements that condense the blue light Lb, the green light Lg, and the red light Lr are integrated for the light-condensing element serving as the base, but a light-condensing element that condenses incident light having other wavelengths may be used as the base. For example, a light-condensing element that condenses near-infrared light, X-rays, or the like may be used as the base.

Note that the present disclosure may also have the following configurations.

<1> A light-condensing element including
a concentric integrated pattern that diffracts and condenses incident light including light having a plurality of different wavelengths, in which
the integrated pattern includes a first wavelength-specific pattern corresponding to a first wavelength of the incident light and a second wavelength-specific pattern corresponding to a second wavelength of the incident light.

<2> The light-condensing element according to <1>, in which
in a case where the first wavelength-specific pattern and the second wavelength-specific pattern include transmission regions that transmit the incident light and are superimposed on each other, the integrated pattern is obtained by mixing the transmission region of the first wavelength-specific pattern and the transmission region of the second wavelength-specific pattern.

<3> The light-condensing element according to <2>, in which
the first wavelength-specific pattern includes, in the transmission region, a first color filter that transmits the incident light having the corresponding first wavelength,
the second wavelength-specific pattern includes, in the transmission region, a second color filter that transmits the incident light having the corresponding second wavelength, and
in a case where the transmission region, which transmits the incident light having the first wavelength, of the first wavelength-specific pattern and the transmission region, which transmits the incident light having the second wavelength, of the second wavelength-specific pattern are superimposed on each other, a region where the first color filter is formed and a region where the second color filter is formed are mixed with each other.

<4> The light-condensing element according to <3>, in which
dithering is formed by mixing the region where the first color filter is formed and the region where the second color filter is formed.

<5> The light-condensing element according to <4>, in which
a dither pattern forming the dithering includes a lattice-shaped pattern, a random pattern, a Bayer array pattern, a void-and-cluster array pattern, and an error diffusion pattern.

<6> The light-condensing element according to <3>, in which
the region where the first color filter is formed and the region where the second color filter is formed are mixed with each other in accordance with sensitivity set for the incident light having the first wavelength and sensitivity set for the incident light having the second wavelength.

<7> The light-condensing element according to <6>, in which
the region where the first color filter is formed and the region where the second color filter is formed are mixed with each other at an area ratio according to the sensitivity set for the incident light having the first wavelength and the sensitivity set for the incident light having the second wavelength.

<8> The light-condensing element according to <3>, in which
the region where the first color filter is formed and the region where the second color filter is formed are mixed with each other by forming, in a region where the transmission regions are superimposed on each other, a third color filter that is different from either the first color filter or the second color filter and transmits incident light including both the incident light having the first wavelength and the incident light having the second wavelength.

<9> The light-condensing element according to any one of <1> to <8>, in which
each of the first wavelength-specific pattern and the second wavelength-specific pattern includes a pattern of an amplitude-type light-condensing element in which a light shielding region and a transmission region are alternately formed.

<10> The light-condensing element according to any one of <1> to <8>, in which
each of the first wavelength-specific pattern and the second wavelength-specific pattern includes a pattern of a phase-type light-condensing element in which a transmission region where a phase difference of incident light is 0 rad and a transmission region where a phase difference of the incident light is n rad are alternately formed.

<11> A light-condensing element including
an integrated pattern that diffracts and condenses incident light including light having a plurality of different wavelengths, in which
the integrated pattern includes a first concentric first wavelength-specific pattern corresponding to a first wavelength of the incident light and a second concentric second wavelength-specific pattern corresponding to a second wavelength of the incident light and having a center position shifted from a center position of the first wavelength-specific pattern by a predetermined value.

<12> The light-condensing element according to <11>, in which
of the incident light condensed by the integrated pattern, the incident light having the first wavelength is transmitted through a first imaging color filter, and the incident light having the second wavelength is transmitted through a second imaging color filter,
an imaging element images the incident light having the first wavelength and transmitted through the first imaging color filter and the incident light having the second wavelength and transmitted through the second imaging color filter,
an image captured by the imaging element is separated into an image of a first color channel of the incident light having the first wavelength, corresponding to the first imaging color filter, and an image of a second color channel of the incident light having the second wavelength, corresponding to the second imaging color filter,
the image of the first color channel and the image of the second color channel are synthesized with center positions of the images coinciding with each other, so that a shift between the center position of the first concentric first wavelength-specific pattern and the center position of the second concentric second wavelength-specific pattern is corrected,
the first wavelength-specific pattern includes, in a transmission region that transmits the incident light having the first wavelength, a first condensing color filter that transmits the incident light having the first wavelength,
the second wavelength-specific pattern includes, in a transmission region that transmits the incident light having the second wavelength, a second condensing color filter that transmits the incident light having the second wavelength, and
the first imaging color filter is equal in transmission characteristic to the first condensing color filter, and the second imaging color filter is equal in transmission characteristic to the second condensing color filter.

<13> The light-condensing element according to <11> or <12>, in which
each of the first wavelength-specific pattern and the second wavelength-specific pattern includes a pattern of an amplitude-type light-condensing element in which a light shielding region and a transmission region are alternately formed.

### REFERENCE SIGNS LIST

1, 1′ Imaging device
11 Light-condensing element
12 Imaging element
13 Signal processing unit
31, 51, 61 to 63 Light-condensing element
81 Color filter
91, 101b, 101g, 101r, 101, 111 Light-condensing element

1. A light-condensing element comprising
a concentric integrated pattern that diffracts and condenses incident light including light having a plurality of different wavelengths, wherein
the integrated pattern includes a first wavelength-specific pattern corresponding to a first wavelength of the incident light and a second wavelength-specific pattern corresponding to a second wavelength of the incident light.

2. The light-condensing element according to claim 1, wherein
in a case where the first wavelength-specific pattern and the second wavelength-specific pattern include transmission regions that transmit the incident light and are superimposed on each other, the integrated pattern is obtained by mixing the transmission region of the first wavelength-specific pattern and the transmission region of the second wavelength-specific pattern.

3. The light-condensing element according to claim 2, wherein
the first wavelength-specific pattern includes, in the transmission region, a first color filter that transmits the incident light having the corresponding first wavelength,
the second wavelength-specific pattern includes, in the transmission region, a second color filter that transmits the incident light having the corresponding second wavelength, and
in a case where the transmission region, which transmits the incident light having the first wavelength, of the first wavelength-specific pattern and the transmission region, which transmits the incident light having the second wavelength, of the second wavelength-specific pattern are superimposed on each other, a region where the first color filter is formed and a region where the second color filter is formed are mixed with each other.

4. The light-condensing element according to claim 3, wherein
dithering is formed by mixing the region where the first color filter is formed and the region where the second color filter is formed.

5. The light-condensing element according to claim 4, wherein
a dither pattern forming the dithering includes a lattice-shaped pattern, a random pattern, a Bayer array pattern, a void-and-cluster array pattern, and an error diffusion pattern.

6. The light-condensing element according to claim 3, wherein
the region where the first color filter is formed and the region where the second color filter is formed are mixed with each other in accordance with sensitivity set for the incident light having the first wavelength and sensitivity set for the incident light having the second wavelength.

7. The light-condensing element according to claim 6, wherein
the region where the first color filter is formed and the region where the second color filter is formed are mixed with each other at an area ratio according to the sensitivity set for the incident light having the first wavelength and the sensitivity set for the incident light having the second wavelength.

8. The light-condensing element according to claim 3, wherein
the region where the first color filter is formed and the region where the second color filter is formed are mixed with each other by forming, in a region where the transmission regions are superimposed on each other, a third color filter that is different from either the first color filter or the second color filter and transmits incident light including both the incident light having the first wavelength and the incident light having the second wavelength.

9. The light-condensing element according to claim 1, wherein
each of the first wavelength-specific pattern and the second wavelength-specific pattern comprises a pattern of an amplitude-type light-condensing element in which a light shielding region and a transmission region are alternately formed.

10. The light-condensing element according to claim 1, wherein
each of the first wavelength-specific pattern and the second wavelength-specific pattern comprises a pattern of a phase-type light-condensing element in which a transmission region where a phase difference of incident light is 0 rad and a transmission region where a phase difference of the incident light is n rad are alternately formed.

11. A light-condensing element comprising
an integrated pattern that diffracts and condenses incident light including light having a plurality of different wavelengths, wherein
the integrated pattern includes a first concentric first wavelength-specific pattern corresponding to a first wavelength of the incident light and a second concentric second wavelength-specific pattern corresponding to a second wavelength of the incident light and having a center position shifted from a center position of the first wavelength-specific pattern by a predetermined value.

12. The light-condensing element according to claim 11, wherein
of the incident light condensed by the integrated pattern, the incident light having the first wavelength is transmitted through a first imaging color filter, and the incident light having the second wavelength is transmitted through a second imaging color filter,
an imaging element images the incident light having the first wavelength and transmitted through the first imaging color filter and the incident light having the second wavelength and transmitted through the second imaging color filter,
an image captured by the imaging element is separated into an image of a first color channel of the incident light having the first wavelength, corresponding to the first imaging color filter, and an image of a second color channel of the incident light having the second wavelength, corresponding to the second imaging color filter,
the image of the first color channel and the image of the second color channel are synthesized with center positions of the images coinciding with each other, so that a shift between the center position of the first concentric first wavelength-specific pattern and the center position of the second concentric second wavelength-specific pattern is corrected,
the first wavelength-specific pattern includes, in a transmission region that transmits the incident light having the first wavelength, a first condensing color filter that transmits the incident light having the first wavelength,
the second wavelength-specific pattern includes, in a transmission region that transmits the incident light having the second wavelength, a second condensing color filter that transmits the incident light having the second wavelength, and
the first imaging color filter is equal in transmission characteristic to the first condensing color filter, and the second imaging color filter is equal in transmission characteristic to the second condensing color filter.

13. The light-condensing element according to claim 11, wherein
each of the first wavelength-specific pattern and the second wavelength-specific pattern comprises a pattern of an amplitude-type light-condensing element in which a light shielding region and a transmission region are alternately formed.
